(19) United States
(12) Patent Application Publication
(10) Pub. No.: US 2019/0196367 A1
(43) Pub. Date: Jun. 27, 2019

(54) IMAGE BEARING MEMBER AND IMAGE FORMING APPARATUS

(71) Applicant: Konica Minolta, Inc., Tokyo (JP)

(72) Inventors: Toshiki HAYAMI, Tokyo (JP); Yoshitada KARIMAI, Tokyo (JP)

(21) Appl. No.: 16/209,357

(22) Filed: Dec. 4, 2018

(30) Foreign Application Priority Data
Dec. 21, 2017 (JP) 2017-245260

(51) Int. Cl. G03G 15/16; G03G 15/00

(52) U.S. Cl. CPC G03G 15/162; G03G 15/5054; G03G 15/161

(57) ABSTRACT

An intermediate transfer belt (image bearing member) includes a base material layer and a surface layer disposed on the base material layer and including an inorganic oxide containing an organic component. A ten-point average roughness of the surface layer is 69% or more of a wavelength of incident light emitted from a sensor for detecting an amount of toner adhering to the image bearing member and less than 20% of an average particle size of the toner.

### CROSS REFERENCE TO RELATED APPLICATIONS

The entire disclosure of Japanese Patent Application No. 2017-245260 filed on Dec. 21, 2017 is incorporated herein by reference in its entirety.

### BACKGROUND

### Technological Field

The present invention relates to an image bearing member and an image forming apparatus.

### Description of Related Art

Generally, an image forming apparatus (a printer, a copier, a facsimile machine, or the like) utilizing electrophotographic process technology irradiates (exposes) a charged photoconductor drum with laser light based on image data, thereby forming an electrostatic latent image. Then, toner is supplied from a developing device to the photoconductor drum on which the electrostatic latent image is formed, whereby the electrostatic latent image is visualized to form a toner image. Furthermore, after this toner image is directly or indirectly transferred to sheet, the toner image is fixed by heating and pressurizing, whereby an image is formed on the sheet.

Furthermore, in the image forming apparatus, a toner adhesion amount is optically detected by a sensor in the photoconductor drum or an intermediate transfer belt (image bearing member), image forming operation is controlled on the basis of a detection result and image quality is improved.

For example, in an image forming apparatus disclosed in Japanese Patent Application Laid-Open No. 2014-109586 (hereinafter referred to as “Patent Literature 1”), for a base material layer including polyimide (PI) (sometimes referred to as a base layer), the use of an intermediate transfer belt coated with a surface layer (sometimes referred to as a superficial layer or a coat layer) containing silicon dioxide (SiO₂) as a main component has been studied.

As in Patent Literature 1, in the intermediate transfer belt having the base material layer and the surface layer, toner adhesion force is reduced and transfer efficiency is improved. However, in the case of detecting the toner adhesion amount in the intermediate transfer belt having the base material layer and the surface layer described above, there is a problem that reflected light beams generated as a result that incident light emitted from a light emitting side of the sensor is reflected by each of the base material layer and the surface layer are interfered with each other, sensor noise is generated on a light receiving side of the sensor and the toner adhesion amount cannot be accurately detected.

### SUMMARY

An object of the present invention is to provide an image bearing member and an image forming apparatus capable of accurately detecting a toner adhesion amount.

In order to realize at least one of the above objects, an image bearing member includes:

a base material layer; and

a surface layer disposed on the base material layer and including an inorganic oxide containing an organic component, in which
a ten-point average roughness of the surface layer is 69% or more of a wavelength of incident light emitted from a sensor for detecting an amount of toner adhering to the image bearing member and less than 20% of an average particle diameter of the toner.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view schematically illustrating an overall configuration of an image forming apparatus according to one embodiment;

FIG. 2 is a diagram illustrating a main part of a control system of the image forming apparatus according to the one embodiment;

FIG. 3 is a diagram schematically illustrating a cross section of an intermediate transfer belt;

FIG. 4 is a diagram for describing interference that occurs in the intermediate transfer belt;

FIG. 5 is a diagram illustrating an example of a cross section of an intermediate transfer belt according to the one embodiment;

FIG. 6 is a table illustrating an example of evaluation results of cleanability and sensor noise according to the one embodiment;

FIG. 7 is a graph illustrating an example of relationship between the content of an organic component in a surface layer and the hardness of the surface layer;

FIG. 8 is a diagram for describing a principle of improving transfer efficiency by the surface layer;

FIG. 9 is a table illustrating an example of an evaluation result of transferability and occurrence of a crack according to a first modification of the one embodiment;

FIG. 10 is a table illustrating an example of an evaluation result of transferability according to a third modification of the one embodiment; and

FIG. 11 is a graph illustrating an example of relationship between the content of the organic component in the surface layer and a film thickness of the surface layer.

### DETAILED DESCRIPTION OF EMBODIMENTS

Hereinafter, one or more embodiments of the present invention will be described with reference to the drawings. However, the scope of the invention is not limited to the disclosed embodiments.

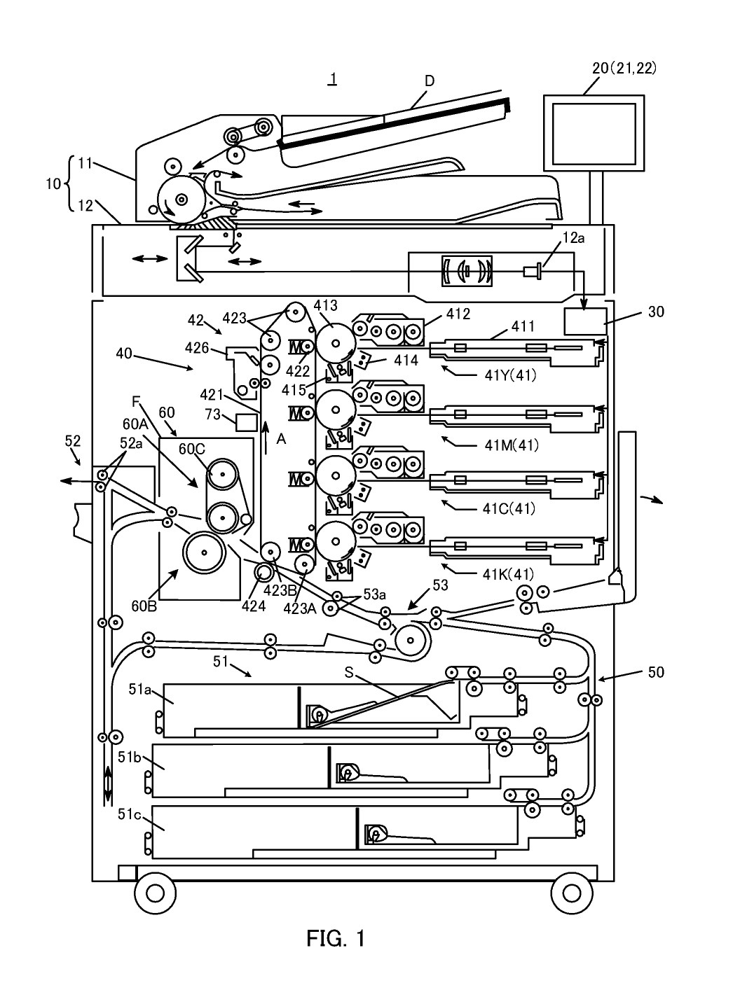

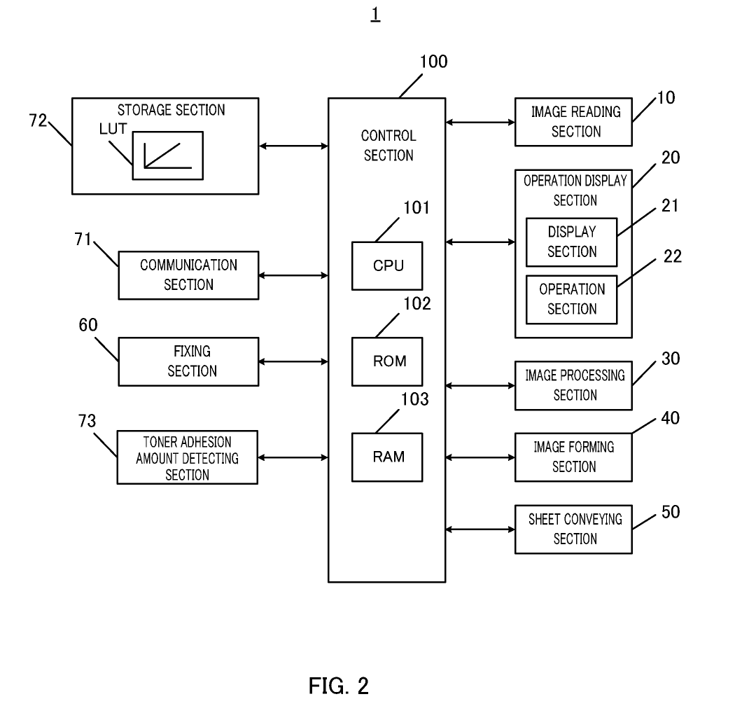

FIG. 1 is a view schematically illustrating an overall configuration of image forming apparatus 1 according to an embodiment of the present invention. FIG. 2 is a diagram illustrating a main part of a control system of image forming apparatus 1 according to the present embodiment. Image forming apparatus 1 illustrated in FIGS. 1 and 2 is an intermediate transfer type color image forming apparatus utilizing electrophotographic process technology. That is, image forming apparatus 1 primarily transfers each color toner image of yellow (Y), magenta (M), cyan (C), and black (K) formed on photoconductor drum 413 to intermediate transfer belt 421 (image bearing member), superimposes the four color toner images on intermediate transfer belt 421, and secondarily transfers the toner images to sheet S (recording medium), thereby forming an image. Note that image forming apparatus 1 may be an image apparatus that forms a single color image (for example, monochrome image).

In image forming apparatus 1, a tandem system in which photoconductor drums 413 corresponding to the four colors of YMCK are disposed in series in a running direction of intermediate transfer belt 421 and the toner image of each color is sequentially transferred to intermediate transfer belt 421 in a single procedure has been adopted.

As illustrated in FIG. 2, image forming apparatus 1 includes image reading section 10, operation display section 20, image processing section 30, image forming section 40, sheet conveying section 50, fixing section 60, and control section 100.

Control section 100 includes central processing unit (CPU) 101, read only memory (ROM) 102, random access memory (RAM) 103, and the like. CPU 101 reads a program corresponding to processing contents from ROM 102, develops the program in RAM 103, and centrally controls the operation of each block of image forming apparatus 1 in cooperation with the developed program. At this time, various data stored in storage section 72 is referred to. Storage section 72 includes, for example, a nonvolatile semiconductor memory (so-called flash memory) or a hard disk drive.

Control section 100 transmits/receives various data to/from an external device (for example, personal computer) connected to a communication network such as a local area network (LAN) and a wide area network (WAN) via communication section 71. For example, control section 100 receives image data transmitted from the external device and form an image on sheet S on the basis of image data (input image data). Communication section 71 includes, for example, a communication control card such as a LAN card.

Image reading section 10 is configured by including automatic document feeding device 11 called an auto document feeder (ADF), document image scanning device 12 (scanner).

Automatic document feeding device 11 conveys document D placed on a document tray by a conveyance mechanism and sends document D to document image scanning device 12. Automatic document feeding device 11 can continuously read images (including both surfaces) of a large number of documents D placed on the document tray at once.

Document image scanning device 12 optically scans the document conveyed on contact glass from automatic document feeding device 11 or the document placed on the contact glass, causes light reflected from the document to form an image onto a light receiving surface of charge coupled device (CCD) sensor 12a, and reads a document image. Image reading section 10 generates input image data on the basis of a reading result by document image scanning device 12. The input image data is subjected to predetermined image processing in image processing section 30.

Operation display section 20 includes, for example, a liquid crystal display (LCD) with a touch panel and functions as display section 21 and operation section 22. Display section 21 displays various operation screens, image status, operation status of each function, and the like according to a display control signal input from control section 100. Operation section 22 includes various operation keys such as numeric keys and a start key, accepts various input operations by a user, and outputs an operation signal to control section 100.

Image processing section 30 includes a circuit and the like that performs digital image processing according to an initial setting or a user setting on the input image data. For example, under the control of control section 100, image processing section 30 performs tone correction on the basis of tone correction data (tone correction table). Furthermore, in addition to the tone correction, image processing section 30 subjects the input image data to various correction processing such as color correction, shading correction and compression processing. Image forming section 40 is controlled on the basis of the image data subjected to these kinds of processing.

Image forming section 40 includes image forming units 41Y, 41M, 41C, and 41K for forming images with color toners of a Y component, an M component, a C component, and a K component on the basis of the input image data, intermediate transfer unit 42 and the like.

Image forming units 41Y, 41M, 41C, and 41K for the Y component, the M component, the C component, and the K component have a similar configuration. For convenience of illustration and description, common constituent elements are denoted by the same reference numerals, and in a case where the constituent elements are distinguished from one another, the constituent elements are represented with Y, M, C, or K added to the reference numerals. In FIG. 1, only the constituent elements of image forming unit 41Y for the Y component are denoted by reference numerals, and the reference numerals of the constituent elements of other image forming units 41M, 41C, 41K are omitted.

Image forming unit 41 includes exposure device 411, developing device 412, photoconductor drum 413, charging device 414, drum cleaning device 415, and the like.

Exposure device 411 includes, for example, a semiconductor laser, and irradiates photoconductor drum 413 with a laser beam corresponding to an image of each color component. As a result, an electrostatic latent image of each color component is formed on a surface of photoconductor drum 413 due to a potential difference from surroundings.

Developing device 412 is, for example, a two-component reversal type developing device, and attaches toner of each color component to the surface of photoconductor drum 413, whereby the electrostatic latent image is visualized to form a toner image. Developing device 412 includes a developing sleeve disposed so as to face photoconductor drum 413 via a developing region. For example, a direct current developing bias having the same polarity as a charging polarity of charging device 414, or a developing bias in which a direct current voltage having the same polarity as the charging polarity of charging device 414 is superimposed on an alternate current voltage is applied to the developing sleeve. As a result, reversal development in which toner is attached to the electrostatic latent image formed by exposure device 411 is performed.

Photoconductor drum 413 includes, for example, an organic photoreceptor in which a photosensitive layer including a resin containing an organic photoconductor is formed on an outer peripheral surface of a drum-shaped metal base.

Control section 100 controls a driving current supplied to a driving motor (not illustrated) that rotates photoconductor drum 413, thereby rotating photoconductor drum 413 at a constant peripheral speed.

Charging device 414 is, for example, an electrification charger, and generates corona discharge, thereby uniformly charging the surface of photoconductor drum 413 into negative polarity.

Drum cleaning device 415 is in contact with the surface of photoconductor drum 413, has a flat plate-shaped drum cleaning blade and the like including an elastic body, and removes the toner that is not transferred to intermediate transfer belt 421 and remains on the surface of photoconductor drum 413.

Intermediate transfer unit 42 includes intermediate transfer belt 421, primary transfer roller 422, a plurality of support rollers 423, secondary transfer roller 424, belt cleaning device 426, and the like.

Intermediate transfer belt 421 includes an endless belt and is stretched in a loop shape around a plurality of support rollers 423. At least one of the plurality of support rollers 423 includes a driving roller and the others include a driven roller. For example, support roller 423A disposed on a downstream side of primary transfer roller 422 for the K component in a belt running direction is preferably a driving roller. This makes it easier to keep the running speed of the belt in a primary transfer section constant. The rotation of driving roller 423A causes intermediate transfer belt 421 to travel at a constant speed in a direction of arrow A.

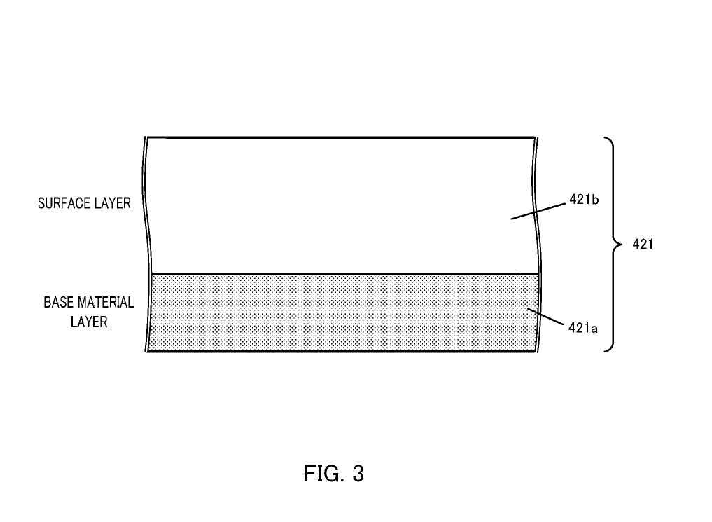

FIG. 3 is a diagram schematically illustrating a cross section of intermediate transfer belt 421. As illustrated in FIG. 3, intermediate transfer belt 421 has at least two layers of base material layer 421a and surface layer 421b disposed on base material layer 421a. For base material layer 421a, for example, a synthetic resin in which a conductive material such as a polyimide (PI) resin, a polyamideimide resin, a polyphenylene sulfide resin, a polyamide resin or the like is dispersed is used. Base material layer 421a may have a single layer configuration or a multi-layer configuration. Furthermore, for surface layer 421b, for example, a material containing silicon dioxide (SiO₂) as a main component is used. For example, for surface layer 421b, a siloxane compound such as methyltrimethoxysilane, dimethyldimethoxysilane, phenyltrimethoxysilane, methyltriethoxysilane may be used as silicon oxide containing an alkyl group. Furthermore, surface layer 421b has at least light permeability.

Note that materials used for base material layer 421a and surface layer 421b are not limited to these materials.

Primary transfer roller 422 is disposed on an inner peripheral surface side of intermediate transfer belt 421 such that primary transfer roller 422 faces photoconductor drum 413 of each color component. A primary transfer nip for transferring the toner image from photoconductor drum 413 to intermediate transfer belt 421 is formed by pressing primary transfer roller 422 against photoconductor drum 413 across intermediate transfer belt 421.

Secondary transfer roller 424 is disposed on an outer peripheral surface side of intermediate transfer belt 421 such that secondary transfer roller 424 faces backup roller 423B disposed on the downstream side of driving roller 423A in the belt running direction. A secondary transfer nip for transferring the toner image from intermediate transfer belt 421 to sheet S is formed by pressing secondary transfer roller 424 against backup roller 423B across intermediate transfer belt 421.

When intermediate transfer belt 421 passes through the primary transfer nip, the toner image on photoconductor drum 413 is sequentially superimposed and primarily transferred to intermediate transfer belt 421. Specifically, a primary transfer bias is applied to primary transfer roller 422, and a charge having a polarity opposite to a polarity of the toner is imparted to a back side of intermediate transfer belt 421 (side in contact with primary transfer roller 422), whereby the toner image is electrostatically transferred to intermediate transfer belt 421.

Thereafter, when sheet S passes through the secondary transfer nip, the toner image on intermediate transfer belt 421 is secondarily transferred to sheet S. Specifically, a secondary transfer bias is applied to secondary transfer roller 424, and a charge having a polarity opposite to that of the toner is imparted to a back side of sheet S (side in contact with secondary transfer roller 424), whereby the toner image is electrostatically transferred to sheet S. Sheet S to which the toner image is transferred is conveyed toward fixing section 60.

Belt cleaning device 426 removes transfer residual toner remaining on the surface of intermediate transfer belt 421 after the secondary transfer. Note that instead of secondary transfer roller 424, a configuration (so-called belt-type secondary transfer unit) in which a secondary transfer belt is stretched in a loop shape on a plurality of support rollers including a secondary transfer roller may be adopted.

Fixing section 60 includes upper fixing section 60A having a fixing surface-side member disposed on a side of a fixing surface of sheet S (surface on which the toner image is formed), lower fixing section 60B having a back surface-side support member disposed on the back side of sheet S (surface opposite to the fixing surface), heating source 60C, and the like. By pressing the back surface-side support member against the fixing surface-side member, a fixing nip for sandwiching and conveying sheet S is formed.

In fixing section 60, sheet S on which the toner image is secondarily transferred and that is conveyed is heated and pressurized at the fixing nip, whereby the toner image is fixed on sheet S. Fixing section 60 is disposed as a unit in fixing device F. Furthermore, an air separation unit that separates sheet S from the fixing surface-side member or the back surface-side support member may be disposed on fixing device F by blowing air.

Sheet conveying section 50 includes sheet feed section 51, sheet ejecting section 52, conveyance path section 53, and the like. Sheet S (standard sheet, special sheet) identified on the basis of a basis weight, a size, and the like is accommodated in each of three sheet feed tray units 51a to 51c constituting sheet feed section 51 for each preset type. Conveyance path section 53 has a plurality of a pair of conveyance rollers such as a pair of registration rollers 53a.

Sheets S accommodated in sheet feed tray units 51a to 51c are sent one by one from the uppermost portion and are conveyed to image forming section 40 by conveyance path section 53. At this time, the inclination of fed sheet S is corrected and the conveyance timing is adjusted by a registration roller section in which the pair of registration rollers 53a is arranged. Then, in image forming section 40, the toner image of intermediate transfer belt 421 is secondarily transferred collectively to one side of sheet S, and the fixing step is performed in fixing section 60. Sheet S on which an image is formed is ejected to the outside of image forming apparatus 1 by sheet ejecting section 52 having sheet ejection roller 52a.

Toner adhesion amount detecting section 73 faces intermediate transfer belt 421 and detects a toner adhesion amount on intermediate transfer belt 421. For example, an image density control (IDC) sensor, a charge coupled device (CCD) image sensor, or the like is used for toner adhesion amount detecting section 73. For example, toner adhesion amount detecting section 73 includes a light sensor including a light emitting element and a light receiving element. In intermediate transfer belt 421, light having an intensity corresponding to the amount of toner adhering to intermediate transfer belt 421 is reflected. For example, as the toner adhesion amount on intermediate transfer belt 421 becomes smaller, stronger light is reflected on intermediate transfer belt 421. Toner adhesion amount detecting section 73 detects the toner adhesion amount on intermediate transfer belt 421 on the basis of a reflection intensity (for example, voltage value) of the reflected light received by the light receiving element. The higher the reflection intensity of the reflected light received by the light receiving element, the smaller the toner adhesion amount detected by toner adhesion amount detecting section 73 becomes.

Control section 100 controls transfer operation (for example, transfer bias) and the like in image forming section 40 on the basis of a detection result (toner adhesion amount) of toner adhesion amount detecting section 73.

As illustrated in FIG. 3, in intermediate transfer belt 421 having base material layer 421a and surface layer 421b, interference between light reflected on the surface of surface layer 421b and light that passes through surface layer 421b and is reflected on base material layer 421a occurs. Due to the interference of the reflected light, sensor noise is generated in the light receiving element of toner adhesion amount detecting section 73.

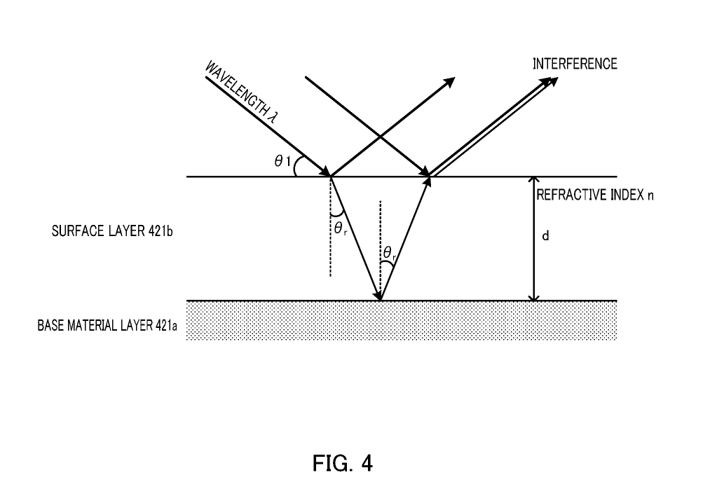

FIG. 4 is a diagram for describing a mechanism of generation of the sensor noise.

In FIG. 4, the wavelength (sensor wavelength) of incident light (sensor light) emitted from the light emitting element (not illustrated) included in toner adhesion amount detecting section 73 is λ, the refractive index of surface layer 421b) is n, and the film thickness of surface layer 421b (thickness of the coat layer) is d. Furthermore, an angle (refraction angle) at which light is incident inside surface layer 421b is θᵣ.

In this case, a condition under which the light reflected on surface layer 421b and the light that passes through surface layer 421b and is reflected on base material layer 421a interfere with each other is expressed by the following equations.

2nd cos θᵣ=mλ (1)

2nd cos θᵣ=(m+(½))λ (2)

In the equations (1) and (2), m is an integer of 0 or more (0, 1, 2, . . . ).

Here, variations (for example, nm to μm order) in the thickness of surface layer 421b coated on base material layer 421a necessarily occur in intermediate transfer belt 421. Due to variations in the thickness of surface layer 421b, variations in an interference condition as illustrated in FIG. 4 also occur in intermediate transfer belt 421. For this reason, variations in the toner adhesion amount detected by toner adhesion amount detecting section 73 (sensor noise) also occur in intermediate transfer belt 421.

Therefore, in order to accurately detect the toner adhesion amount, it is desirable to reduce the sensor noise caused by the variations in film thickness d of surface layer 421b.

Therefore, in the present embodiment, in order to reduce the sensor noise, roughness is imparted to the surface of surface layer 421b that is the outermost layer surface of intermediate transfer belt 421.

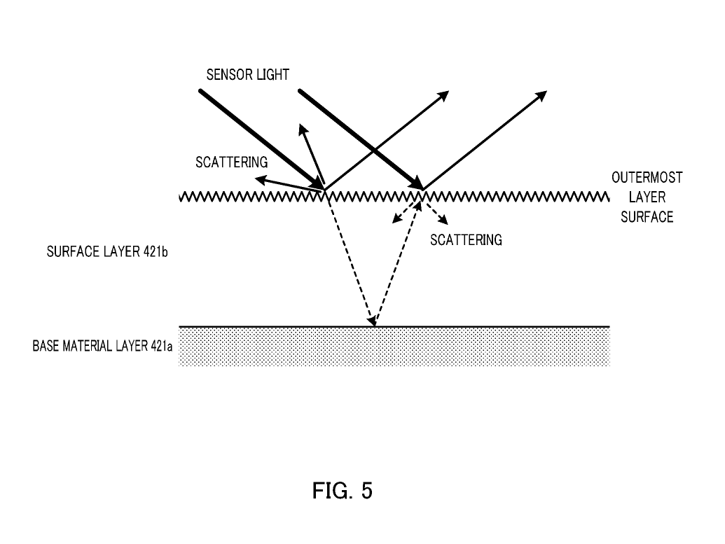

FIG. 5 illustrates an example of a cross section of intermediate transfer belt 421 according to the present embodiment. As illustrated in FIG. 5, the roughness is imparted to surface layer 421b (outermost layer surface).

As illustrated in FIG. 5, by imparting the roughness to surface layer 421b of intermediate transfer belt 421, the sensor light incident from toner adhesion amount detecting section 73 (light emitting element) is scattered on the surface of surface layer 421b.

Similarly, as illustrated in FIG. 5, among the sensor light, light that passes through surface layer 421b and is reflected on base material layer 421a (represented by a broken line arrow) is scattered on the surface of surface layer 421b.

As described above, the sensor light incident from the light emitting element and the reflected light from base material layer 421a are each scattered on the surface to which the roughness is imparted in surface layer 421b. Therefore, the light reflected from the surface of surface layer 421b and the light that passes through surface layer 421b and is reflected on base material layer 421a becomes difficult to interfere with each other. Therefore, occurrence of the sensor noise due to the interference at surface layer 421b can be suppressed. As a result, toner adhesion amount detecting section 73 can accurately measure the amount of toner adhering to intermediate transfer belt 421.

Here, the larger surface roughness “Rz” of surface layer 421b is, the larger the degree of scattering of the incident sensor light in surface layer 421b and the reflected light from base material layer 421a becomes, and the sensor noise is further reduced. However, the larger surface roughness Rz of surface layer 421b is, the deeper a groove formed on the surface of surface layer 421b becomes. Therefore, for example, in belt cleaning device 426, the transfer residual toner easily passes through without being removed and there is a possibility of a cleaning failure.

Therefore, surface roughness Rz of surface layer 421b is desirably designed in consideration of at least both reduction of the sensor noise in toner adhesion amount detecting section 73 and ensuring of cleanability in belt cleaning device 426.

The present inventors evaluated the sensor noise in toner adhesion amount detecting section 73 and the cleanability in belt cleaning device 426 by the following method and criteria.

Note that in the following description, surface roughness Rz (μm) of surface layer 421b is a ten-point average roughness measured by a surface roughness measuring device Surfcorder SE3500 manufactured by Kosaka Laboratory Ltd. Furthermore, as measurement conditions of surface roughness Rz of surface layer 421b, a feed speed is 0.2 mm/sec, a trace length is 12.5 mm, a cutoff value λc is 2.5 mm, and an evaluation length is a length obtained by multiplying a cutoff value by 5.

Furthermore, a method (manufacturing method) of imparting surface roughness Rz of surface layer 421b includes a dip coating method, a spray method, an atmospheric pressure plasma enhanced chemical vapor deposition (CVD) method, and the like, but is not limited to these methods.

Furthermore, the resistance (surface resistivity) of base material layer 421a is preferably, for example, 9.0 to 12.0 log Ω/□. Furthermore, the resistance of surface layer 421b is preferably a value higher by 0.5 to 2.0 log Ω/□ than the resistance of base material layer 421a. Furthermore, the resistance of intermediate transfer belt 421 in a state in which base material layer 421a and surface layer 421b are laminated is preferably 9.1 to 12.1 log Ω/□, more preferably 9.5 to 11.0 log Ω/□. Note that with a resistivity measuring device (Hiresta-UP, manufactured by Mitsubishi Chemical Analytech Co., Ltd.), the resistance of intermediate transfer belt 421 was determined by applying a voltage of 500 V with insulating plates facing each other. Furthermore, the resistance of surface layer 421b alone was obtained by making an opposing plate conductive.

Table 1 illustrates each parameter of image forming apparatus 1 (evaluator) used in the evaluation of the sensor noise and the cleanability.

TABLE 1

| Machine | | | Full color machine adopting intermediate |
|---|---|---|---|
| | | | transfer member |
| Speed | | | 400 mm/sec |
| Intermediate transfer belt 421 | | | Described separately |
| Secondary transfer | Backup roller | Material | Acrylonitrile-butadiene rubber (NBR) |
| section | 423B | Shape | φ 38 straight |
| | | Physical | Aske-C71°, 7.5 logΩ |
| | | property | |
| | Secondary transfer roller | Material | SUS Roller |
| | 424 | Shape | φ 38 straight |
| | | Physical | — |
| | | property | |

| | | |
|---|---|---|
| | Pressing force | 80 N |
| Belt cleaning device | Blade material | Urethane rubber |
| 426 | Contact force | 20 N |
| | Contact angle | 20° |
| Toner adhesion amount | Wavelength | 870 nm |
| detection section 73 | Incidence angle | 10° |
| | Output voltage | 0 to 4 V |

| | |
|---|---|
| Stretching roller | SUS-made φ 38 straight |

Base material layer 421a of intermediate transfer belt 421 uses a material including a polyimide resin and having a film thickness of 65 μm and resistance of 10.2 log Ω/□. Surface layer 421b of intermediate transfer belt 421 uses a material containing silicon dioxide as a main component and having a material having a film thickness of 1.6 μm.

Furthermore, for the material used for surface layer 421b, both masses of tetraalkoxysilane (Si(OR)₄) and methyltrimethoxysilane ((CH₃)₃SiCH₃) to be blended are adjusted such that the content of an organic component in surface layer 421b is 20 mass %. Note that a reason why the organic component is contained in surface layer 421b is to prevent a crack from occurring in a case where the component of surface layer 421b cannot follow the fluctuations of intermediate transfer belt 421 stretched around the roller in a case where the component of surface layer 421b is only silicon dioxide.

Under the above conditions, intermediate transfer belt 421 was manufactured by varying surface roughness Rz of surface layer 421b in the range of 0.4 to 1.5 μm (patterns (1) to (11)).

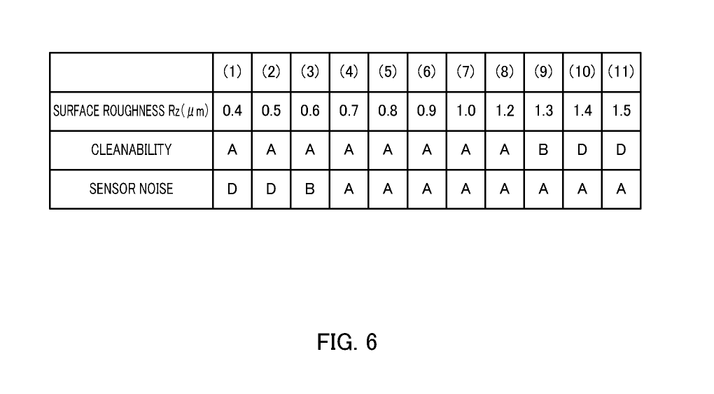

FIG. 6 illustrates the results of evaluating the cleanability and the sensor noise in image forming apparatus 1 according to the following evaluation criteria with respect to the patterns (1) to (11).

Specifically, as a cleanability evaluation method, according to a state of a wiping residue in a case where the toner adhesion amount on intermediate transfer belt 421 was 8 gsm and the toner was made to rush into belt cleaning device 426, the cleanability was evaluated as follows.
A: No wiping residue
B: Although there is a wiping residue, the wiping residue is acceptable in actual operation.
D: There is a wiping residue, which is not acceptable in actual operation.

Furthermore, as a sensor noise evaluation method, intermediate transfer belt 421 is driven while the sensor light is emitted from toner adhesion amount detecting section 73, sensor reflection intensity (voltage value) on the bare surface of intermediate transfer belt 421 is measured, and the sensor noise was evaluated as follows according to a difference [V] between the maximum value of the measured values and the minimum value thereof.
A: Less than 0.1 V
B: 0.1 to 0.15 V
D: Larger than 0.15 V

As illustrated in FIG. 6, the cleanability was “A” when surface roughness Rz of surface layer 421b was 1.2 μm or less (patterns (1) to (8)), “B” when surface roughness Rz of surface layer 421b was 1.3 μm (pattern (9)), and “D” when surface roughness Rz of surface layer 421b was 1.4 μm or more (patterns (10) and (11)). That is, from the viewpoint of the cleanability, surface roughness Rz of surface layer 421b is preferably 1.3 μm or less.

Furthermore, as illustrated in FIG. 6, the sensor noise was “D” when surface roughness Rz of surface layer 421b was 0.5 μm or less (patterns (1) and (2)), “B” when surface roughness Rz of surface layer 421b was 0.6 μm (pattern (3)), and “A” when surface roughness Rz of surface layer 421b was 0.7 μm or more (patterns (4) to (11)). That is, from the viewpoint of the sensor noise, surface roughness Rz of surface layer 421b is preferably 0.6 μm or more.

From the above, in the evaluation results illustrated in FIG. 6, in consideration of both of the cleanability and the sensor noise, surface roughness Rz of surface layer 421b is desirably a value in the range of 0.6 μm or more and 1.3 μm or less. That is, when surface roughness Rz is less than a lower limit value thereof (0.6 μm), the degree of scattering of light on the surface of surface layer 421b becomes small and it becomes difficult to suppress the sensor noise. Furthermore, in a case where surface roughness Rz is larger than an upper limit value thereof (1.3 μm), the cleanability by belt cleaning device 426 deteriorates.

Furthermore, as illustrated in FIG. 6, surface roughness Rz of surface layer 421b is more desirably a value in the range of 0.7 μm or more and 1.2 μm or less. By setting surface roughness Rz of surface layer 421b within the range of 0.7 μm or more and 1.2 μm or less, good performance (“A”) can be obtained in terms of both of the cleanability and the sensor noise.

Here, as illustrated in FIG. 6, the lower limit value of surface roughness Rz is determined by the sensor noise. Furthermore, the sensor noise varies depending on the wavelength λ of the sensor. For example, under the conditions illustrated in Table 1, the sensor wavelength λ is 0.87 μm, and as illustrated in FIG. 6, the lower limit value of surface roughness Rz is 0.6 μm. Therefore, a study by the inventors of the present invention has found that surface roughness Rz needs to be 69% or more with respect to the sensor wavelength.

Furthermore, as described above, the upper limit value of surface roughness Rz is determined due to the cleanability. Furthermore, the cleanability varies depending on a toner particle size to be used. For example, an average particle diameter of the toner used in the evaluation illustrated in FIG. 6 is 7 μm, and as illustrated in FIG. 6, the upper limit value of surface roughness Rz is 1.4 μm (that is, pattern (9) in FIG. 6). Therefore, a study by the present inventors has found that surface roughness Rz needs to be less than 20% with respect to the toner particle size.

Therefore, in the present embodiment, it suffices that that surface roughness (ten-point average roughness) Rz of surface layer 421b of intermediate transfer belt 421 is 69% or more of the wavelength λ of incident light emitted from toner adhesion amount detecting section 73 to intermediate transfer belt 421 and less than 20% of the average particle size of the toner to be used.

As a result, in the present embodiment, image forming apparatus 1 can accurately detect the toner adhesion amount by suppressing a sensor noise level in intermediate transfer belt 421 with respect to toner adhesion amount detecting section 73, good cleanability can be obtained in belt cleaning device 426.

For example, image forming apparatus 1 can accurately control the transfer operation by accurately detecting the toner adhesion amount. Therefore, image forming apparatus 1 can form an electric field enough for the toner to move with respect to a depressed portion of paper having depressed and raised portions (for example, embossed paper) and ensure good transferability.

Note that in the present embodiment, a case where the content of the organic component in surface layer 421b is 20 mass % has been described, but the embodiment of the present invention is not limited to the case. Here, there is a tendency that the larger the content of the organic component in surface layer 421b becomes, the more the transferability deteriorates. A mechanism in which the transferability tends to deteriorate may be as follows.

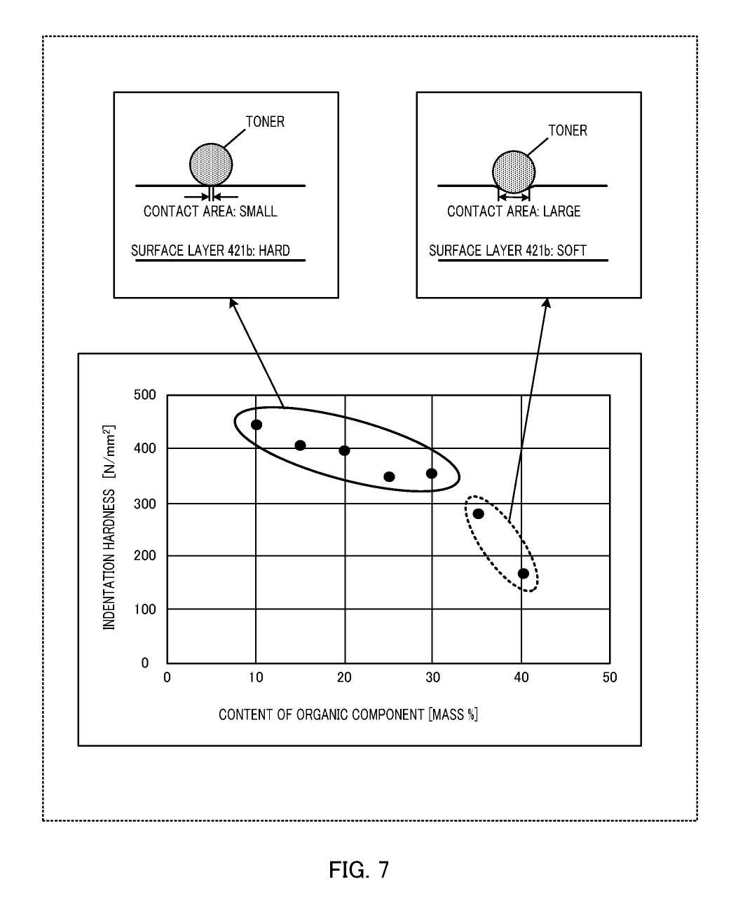

FIG. 7 illustrates an example of relationship between the content of the organic component [mass %] in surface layer 421b and the hardness (indentation hardness) [N/mm²] of surface layer 421b. As illustrated in FIG. 7, it can be seen that the larger the content of the organic component becomes, the smaller the hardness of surface layer 421b becomes. As illustrated in FIG. 7, in a case where the content of the organic component is large and surface layer 421b is soft, a contact area between surface layer 421b and the toner increases, as compared with the case where the content of the organic component is small and surface layer 421b is hard. Therefore, the larger the content of the organic component becomes, the larger the contact area between surface layer 421b and the toner becomes. As a result, the physical adhesion of the toner to surface layer 421b increases, resulting in deterioration of the transferability.

For example, conventionally (for example, in the case of an intermediate transfer belt having only a base material layer), the indentation hardness of a polyimide (PI) resin that has been used as a base material layer is about 320 N/mm². Therefore, in the present embodiment, the hardness of surface layer 421b is desirably 320 N/mm² or more in a similar manner. In FIG. 7, in a case where the content of the organic component exceeds 30 mass % (range surrounded by a dotted line in FIG. 7), the hardness of surface layer 421b is less than 320 N/mm². That is, in a case where the content of the organic component in surface layer 421b exceeds 30 mass %, there is a possibility that the transferability in intermediate transfer belt 421 deteriorates.

Therefore, the content of the organic component in surface layer 421b needs to be 30 mass % or less. Meanwhile, in a case where the content of the organic component in surface layer 421b is too small, a crack is likely to occur as described above. Therefore, for example, the content of the organic component needs to be 10 mass % or more. Therefore, in the present embodiment, the content of the organic component in surface layer 421b may be in the range of 10 mass % or more and 30 mass % or less (range surrounded by a solid line illustrated in FIG. 7).

(First Modification)

In a first modification, a design range of a film thickness of surface layer 421b is defined.

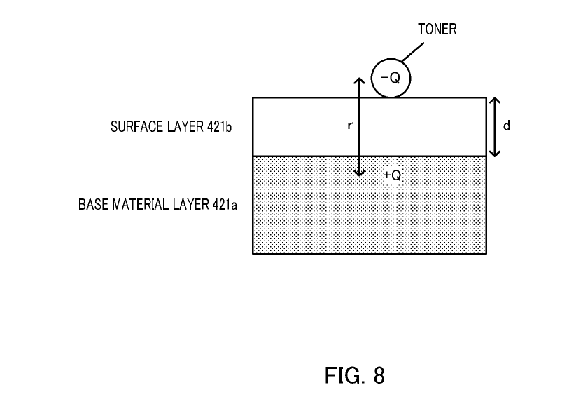

As illustrated in FIG. 8, in a case where intermediate transfer belt 421 includes base material layer 421a (PI layer) and surface layer 421b (coating layer) having resistance higher than that of base material layer 421a, since the resistance of surface layer 421b is high, when toner adheres to intermediate transfer belt 421 by primary transfer, a counter charge opposite to a charge of the toner (+Q) is generated in base material layer 421a.

Here, electrostatic adhesion force F between the toner and intermediate transfer belt 421 is represented by the following equation (3).

$$F = \frac{1}{4 πɛ} \times \frac{{q}^{2}}{{r}^{2}} \qquad ( 3 )$$

That is, the longer distance r between the toner and the counter charge opposite to the charge of the toner is, the smaller electrostatic adhesion force F between the toner and intermediate transfer belt 421 becomes. When electrostatic adhesion force F between the toner and intermediate transfer belt 421 is reduced, transfer efficiency (transferability) is improved. Therefore, in intermediate transfer belt 421 illustrated in FIG. 8, the larger film thickness (“d”) of surface layer 421b is, the longer distance r between the toner and the counter charge opposite to the charge of the toner becomes. As a result, the transfer efficiency (transferability) improves.

Meanwhile, an organic component is included in surface layer 421b of intermediate transfer belt 421 in order to prevent occurrence of a crack. However, even if surface layer 421b includes the organic component, there is a possibility that a crack of surface layer 421b occurs due to stress caused by curvature of a stretched roller, pressing force at a transfer nip (primary transfer nip or secondary transfer nip), and the like. In particular, the larger film thickness d of surface layer 421b is, the more a crack is likely to occur.

Therefore, film thickness d of surface layer 421b is desirably designed in consideration of at least both ensuring of good transferability and prevention of occurrence of a crack in surface layer 421b. Therefore, in the first modification, the design of the film thickness of surface layer 421b that can ensure good transferability while preventing occurrence of a crack in surface layer 421b will be described.

The present inventors evaluated transferability and occurrence of a crack by the following method and criteria. Note that in the first modification, materials and each parameter of image forming apparatus 1 (evaluator) used in evaluating transferability and occurrence of a crack are similar to those in the above embodiment (for example, Table 1).

Furthermore, in the first modification, surface roughness Rz of surface layer 421b is 0.6 μm. However, surface roughness Rz is not limited to 0.6 μm and may be a value within the range described in the above embodiment.

Under the above conditions, intermediate transfer belt 421 was manufactured by varying film thickness d of surface layer 421b in the range of 0.4 to 3.4 μm (patterns (1) to (13)). Note that film thickness d is an average value of film thicknesses measured at any 12 places on intermediate transfer belt 421.

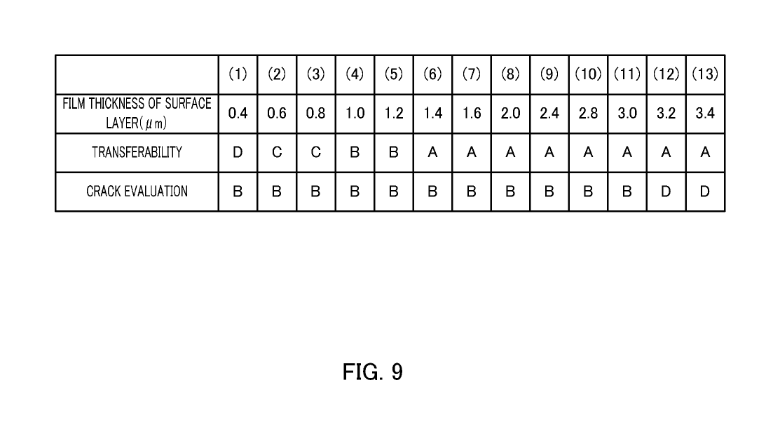

FIG. 9 illustrates the results of evaluating transferability and occurrence of a crack in image forming apparatus 1 according to the following evaluation criteria with respect to patterns (1) to (13).

Specifically, as a transferability evaluation method, a solid image was output to embossed paper (LEATHAC 66, white, 302 gsm, manufactured by Tokushu Tokai Paper Co., Ltd.) (“LEATHAC” is a registered trademark of the company) a degree of blank in a depressed portion was taken as transferability and transferability was evaluated with rankings as follows.
A: There is no problem with the entire surface.
B: There is a blank portion depending on place, but this is acceptable in actual operation.
C: There is a blank portion, which is not acceptable in actual operation.
D: There are blanks on the entire surface.

Furthermore, as an evaluation method of a crack in surface layer 421b, primary transfer and secondary transfer were crimped, and with voltages of 2 kV and 3 kV applied respectively to the primary transfer and the secondary transfer, idling for 200 hr was performed. Thereafter, by visual observation of the surface, the presence or absence of a crack was evaluated as follows.
A: There is a crack.
D: There is no crack.

As illustrated in FIG. 9, the transferability was “D” when the film thickness of surface layer 421b was 0.4 μm (pattern (1)), “C” when the film thickness of surface layer 421b was 0.6 μm and 0.8 μm (patterns (2) and (3)), “B” when the film thickness of surface layer 421b was 1.0 μm and 1.2 μm (patterns (4) and (5)), and “A” when the film thickness of surface layer 421b was 1.4 μm or more (patterns (6) to (13)). That is, from the viewpoint of ensuring the transferability, the film thickness of surface layer 421b is preferably 1.0 μm or more.

In other words, by setting the film thickness of surface layer 421b to 1.0 μm or more, image forming apparatus 1 can ensure good transferability also for the depressed portion of the embossed paper.

Furthermore, as illustrated in FIG. 9, the crack evaluation in surface layer 421b was “B” when the film thickness of surface layer 421b was 3 μm or less (patterns (1) to (11)), and “D” when the film thickness of surface layer 421b was 3.2 μm or more (patterns (12) and (13)). That is, from the viewpoint of the crack evaluation in surface layer 421b, the film thickness of surface layer 421b is preferably 3.0 μm or less.

From the above, in the evaluation results illustrated in FIG. 9, if both of the transferability and the prevention of occurrence of a crack are taken into consideration, the film thickness of surface layer 421b is desirably in the range of 1.0 μm or more and 3.0 μm or less. That is, when the film thickness of surface layer 421b is less than the lower limit value thereof (1.0 μm), for example, distance r illustrated in FIG. 8 becomes short, electrostatic adhesion force F between the toner and intermediate transfer belt 421 increases, and the transferability deteriorates. Furthermore, in a case where the film thickness of surface layer 421b is larger than the upper limit value (3.0 μm), a crack occurs.

Furthermore, as illustrated in FIG. 9, the film thickness of surface layer 421b is more desirably in the range of 1.4 to 3.0 μm. By setting the film thickness of surface layer 421b within the range of 1.4 to 3.0 μm, good transferability (“A”) can be obtained without occurrence of a crack.

As described above, according to the first modification, image forming apparatus 1 can ensure good transferability while preventing occurrence of a crack in intermediate transfer belt 421.

(Second Modification)

In a second modification, intermediate transfer belt 421 adopts a configuration in which an intermediate layer (not illustrated) is disposed between base material layer 421a and surface layer 421b in addition to base material layer 421a and surface layer 421b.

The intermediate layer may have, for example, an elastic layer. The elastic layer may include, as a main component, for example, rubber in which a conductive material or the like is dispersed. Furthermore, as the rubber constituting the elastic layer, acrylonitrile-butadiene rubber, butadiene rubber, chloroprene rubber, urethane rubber, and the like may be used, but the rubber is not limited thereto.

The inventors of the present invention evaluated the transferability of intermediate transfer belt 421 including the intermediate layer by the following method and criteria. Note that in the second modification, materials, each parameter, and an evaluation method of transferability of image forming apparatus 1 (evaluator) used in the evaluation of transferability are similar to those in the first modification.

Furthermore, in the second modification, the intermediate layer uses NBR, a material having a film thickness of 150 μm and resistance of 10.2 log Ω/□. Furthermore, surface roughness Rz of surface layer 421b is 0.8 μm and the film thickness is 1.5 μm. However, surface roughness Rz and the film thickness of surface layer 421b are not limited to these values.

As the evaluation result of the second modification, the transferability was “A”: There is no problem with the entire surface” (not illustrated). As described above, according to the second modification, by providing intermediate transfer belt 421 with the intermediate layer, good transferability can be obtained.

(Third Modification)

In a third modification, a resistance value difference between surface layer 421b and base material layer 421a is defined.

As described above, it has been found that in a case where the content of the organic component in surface layer 421b is large (for example, in a case where the content of the organic component in surface layer 421b exceeds 30 mass %), transferability deteriorates when continuous paper passing (continuous printing) is performed. This deterioration of the transferability is presumably caused by that the resistance of surface layer 421b decreases due to energization of a transfer section. More specifically, in surface layer 421b, bonding force with an inorganic component portion of Si—O is very strong, but bonding force with an organic component portion of Si—R is weak. For this reason, the bonding of Si—R is cut by the energization of the transfer section and conductivity is exhibited, whereby the resistance of the whole of surface layer 421b decreases. This decrease in the resistance of the whole of surface layer 421b is thought to cause the deterioration of the transferability. When the resistance of surface layer 421b decreases, a difference in resistance between surface layer 421b and base material layer 421a disappears and the principle as described with reference to FIG. 8 (that is, principle that the counter charge opposite to the charge of the toner appears not in surface layer 421b but in base material layer 421a) no longer works.

Furthermore, as described in the first modification (FIG. 9), the larger the film thickness of surface layer 421b is, the better transferability can be obtained. Therefore, the larger the film thickness of surface layer 421b is, the more conspicuous a tendency that the transferability deteriorates due to the decrease in the resistance of surface layer 421b due to continuous paper passing becomes.

Therefore, in the third modification, in a case where the content of the organic component in surface layer 421b is large (for example, in the case of 30 mass % or more), the larger the film thickness of surface layer 421b is, the lower resistance of base material layer 421a is designed. In other words, in a case where the content of the organic component in surface layer 421b is large, the larger the film thickness of surface layer 421b is, the larger the resistance value difference between surface layer 421b and base material layer 421a is made.

As a result, even in a case where the resistance of surface layer 421b decreases due to energization of the transfer section described above, the resistance value difference (resistance gap) between surface layer 421b and base material layer 421a can be maintained. Therefore, the principle as described with reference to FIG. 8 works and good transferability can be maintained.

The present inventors evaluated the transferability in the third modification by the following method and criteria. Note that in the third modification, materials and each parameter of image forming apparatus 1 (evaluator) used in the evaluation of the transferability are similar to those in the first modification.

Furthermore, in the third modification, base material layer 421a of intermediate transfer belt 421 includes a material having a polyimide resin, a film thickness of 65 μm, and resistance of 9.5 log Ω/□, and surface layer 421b of intermediate transfer belt 421 uses a material containing silicon dioxide as a main component and having a film thickness of 3.0 μm is used.

Furthermore, for the material used for surface layer 421b, both masses of tetraalkoxysilane (Si(OR)₄) and methyltrimethoxysilane ((CH₃)₃SiCH₃) to be blended are adjusted such that the content of an organic component is 35 mass %.

Under the above conditions, intermediate transfer belt 421 was manufactured. In this case, 11.8 log Ω/□ was obtained as a resistance value of surface layer 421b. That is, the resistance value difference between surface layer 421b and base material layer 421a is 2.3 digits.

Furthermore, in the evaluation of the transferability, as a comparative example with the third modification, intermediate transfer belt 421 in a case where the surface resistivity of base material layer 421a is 10.2 log Ω/□ was also manufactured. That is, in the comparative example, the resistance value difference between surface layer 421b and base material layer 421a is in 1.6 digits smaller than that of the third modification (2.3 digits).

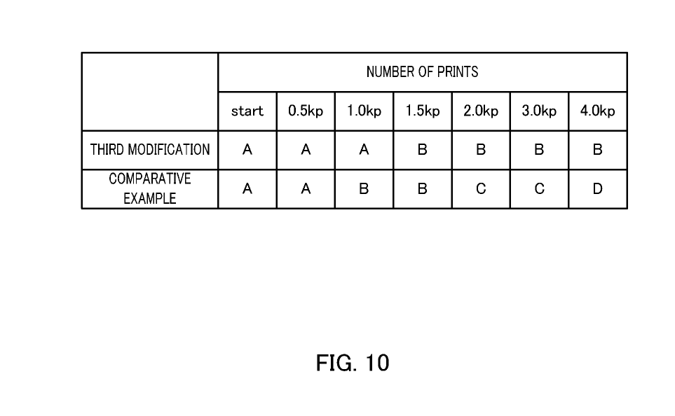

FIG. 10 illustrates the results of evaluating the transferability in the third modification and the comparative example according to the following evaluation criteria.

Specifically, as a transferability evaluation method, the transferability at the time of continuous printing from the time of print start (start) until the printing number of prints 4 kp were evaluated (evaluated with “A”, “B”, “C”, and “D” as with the first modification).

As illustrated in FIG. 10, the transferability in the third modification was “A” until the number of prints reached 1.0 kp and “B” when the number of prints was 1.5 kp to 4.0 kp. That is, in the third modification, good transferability can be maintained at least until the number of prints reaches 4.0 kp. Meanwhile, the transferability in the comparative example was “A” until the number of prints reached 0.5 kp, “B” when the number of prints was 1.0 kp to 1.5 kp, “C” when the number of prints was 2.0 kp to 3.0 kp, and “D” when the number of prints was 4.0 kp. That is, in the comparative example, good transferability cannot be maintained after the number of prints reaches 2.0 kp.

Here, the measured value of the resistance of surface layer 421b alone after the number of prints passed 4 kp as illustrated in FIG. 10 was 10.5 log Ω/□. Meanwhile, there is no change in the resistance of base material layer 421a. The resistance of base material layer 421a is 9.5 log Ω/□ in the third modification and 10.2 log Ω/□ in the comparative example. That is, in the third modification, even in a case where the resistance of surface layer 421b decreases due to energization of the transfer section at the time of continuous printing, the resistance value difference between surface layer 421b and base material layer 421a can be maintained to be one digit. In contrary to this, in the comparative example, since the resistance of surface layer 421b decreased due to energization of the transfer section at the time of continuous printing, the resistance value difference between surface layer 421b and base material layer 421a was reduced to 0.3 digits.

As described above, in the third modification, even in a case where the resistance of surface layer 421b decreases due to energization of the transfer section like at the time of continuous printing, good transferability can be maintained by maintaining the resistance value difference between surface layer 421b and base material layer 421a.

Furthermore, in FIG. 10, a case where the film thickness of surface layer 421b is 3.0 μm and the resistance value difference between surface layer 421b and base material layer 421a is 2.3 digits has been described, but the embodiment of the present invention is not limited to these values. For example, in a case where the content of the organic component in surface layer 421b is more than 30 mass %, the film thickness of surface layer 421b is C [μm], the resistance value difference between surface layer 421b and base material layer 421a is D [log Ω/□], it suffices to satisfy the relationship of formula (4),

0.6×C+0.2≤D (4).

By satisfying the relationship of formula (4), good transferability can be maintained in intermediate transfer belt 421.

(Fourth Modification)

In a fourth modification, relationship between the content of an organic component and a film thickness in surface layer 421b is defined.

As described above, it has been found that the larger the content of the organic component in surface layer 421b becomes, the more transferability deteriorates (for example, see FIG. 7). Meanwhile, as described above, it has been found that as film thickness d of surface layer 421b is made larger, the transferability improves (for example, see FIG. 8).

Therefore, in the fourth modification, the larger the content of the organic component in surface layer 421b becomes, the larger the film thickness of surface layer 421b is made.

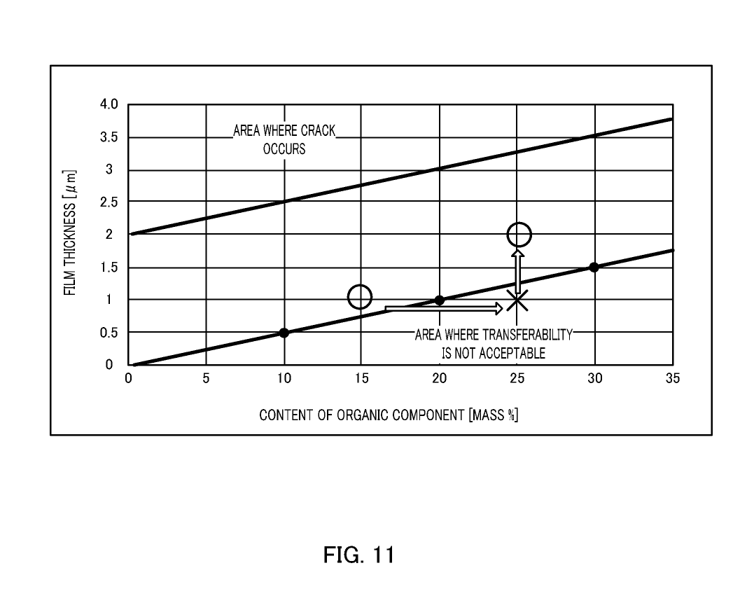

FIG. 11 illustrates an example of the relationship between the content [mass %] of the organic component in surface layer 421b and the film thickness [μm] of surface layer 421b.

As illustrated in FIG. 11, in a case where the film thickness of surface layer 421b is small, the transferability is likely to deteriorate and in a case where the film thickness of surface layer 421b is large, a crack is likely to occur. In addition, as illustrated in FIG. 11, as the content of the organic component in surface layer 421b increases, the hardness of surface layer 421b decreases. Therefore, a crack is less likely to occur, but the transferability is likely to deteriorate.

For example, as illustrated in FIG. 11, it can be seen that in a case where the film thickness of surface layer 421b is 1 μm, good transferability is obtained when the content of the organic component in surface layer 421b is 15 mass %, whereas good transferability cannot be obtained when the content of the organic component is 25 mass % that is more than 20 mass %. Meanwhile, as illustrated in FIG. 11, it can be seen that in a case where the content of the organic component in surface layer 421b is 25 mass %, good transferability can be obtained when the film thickness of surface layer 421b is 2 μm.

As described above, by making the film thickness of surface layer 421b larger as the content of the organic component in surface layer 421b is larger, deterioration of transferability due to the content of the organic component in surface layer 421b can be supplemented by improvement of the transferability due to the film thickness of surface layer 421b, and good transferability can be ensured.

For example, in a case where the content of the organic component in surface layer 421b is A [mass %] and the film thickness of surface layer 421b is B [μm], it suffices to satisfy the relationship of formula (5),

0.05×A<B<0.05×A+2 (5).

By satisfying the relationship of the formula (5), good transferability can be ensured in intermediate transfer belt 421.

Each modification of the present embodiment has been described above.

Note that in the above embodiment, intermediate transfer belt 421 may further include a protective layer on surface layer 421b. This makes it possible to suppress deterioration of surface layer 421b.

Furthermore, in the above embodiment, intermediate transfer belt 421 (intermediate transfer member) has been described as an image bearing member including base material layer 421a and surface layer 421b disposed on base material layer 421a. However, an embodiment of the present invention is not limited to the above embodiment and the embodiment of the present invention can be applied also to other image bearing members (for example, photoconductor drum 413) on which a toner image adhesion amount is detected.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image bearing member, comprising:
a base material layer; and
a surface layer disposed on the base material layer and including an inorganic oxide containing an organic component, wherein
a ten-point average roughness of the surface layer is 69% or more of a wavelength of incident light emitted from a sensor for detecting an amount of toner adhering to the image bearing member and less than 20% of an average particle diameter of the toner.

2. The image bearing member according to claim 1, wherein the inorganic oxide is silicon dioxide containing an alkyl group, and the ten-point average roughness is 0.6 μm or more and 1.3 μm or less.

3. The image bearing member according to claim 1, wherein in a case where content of the organic component is A mass % and a film thickness of the surface layer is B μm, relationship of formula (1) is satisfied,
0.05×A<B<0.05×A+2 (1).

4. The image bearing member according to claim 1, wherein the film thickness of the surface layer is 1.0 μm or more and 3.0 μm or less.

5. The image bearing member according to claim 1, wherein the content of the organic component is 10 mass % or more and 30 mass % or less.

6. The image bearing member according to claim 1, wherein in a case where the content of the organic component is more than 30 mass %, when the film thickness of the surface layer is C μm and a resistance value difference between the surface layer and the base material layer is D log Ω/□, relationship of formula (2) is satisfied,
0.6×C+0.2≤D (2).

7. The image bearing member according to claim 1, further comprising an intermediate layer disposed between the base material layer and the surface layer.

8. An image forming apparatus, comprising the image bearing member according to claim 1.
